(19) United States
(12) Patent Application Publication
(10) Pub. No.: US 2009/0106999 A1
(43) Pub. Date: Apr. 30, 2009

(54) Device for hardening material hardenable by electromagnetic radiation action in particular uv-varnish or thermohardening varnish in particular for coating of an object

(75) Inventor: Werner Swoboda, Boeblingen (DE)

Correspondence Address: FACTOR & LAKE, LTD, 1327 W. WASHINGTON BLVD., SUITE 5G/H, CHICAGO, IL, 60607, US

(73) Assignee: EISENMANN MASCHINENBAU GMBH & CO. KG, Boblingen (DE)

(21) Appl. No.: 10/565,752

(22) PCT Filed: Jul. 13, 2004
(86) PCT No.: PCT/EP04/07696

§ 371 Date: Jul. 19, 2006

(30) Foreign Application Priority Data
Jul. 24, 2003 (DE) 103 35 005.5
May 13, 2004 (DE) 10 2004 023 536.8

(51) Int. Cl. F26B 3/34; F26B 25/00

(52) U.S. Cl. 34/105; 34/275; 118/58; 250/504 R; 250/505.1

(57) ABSTRACT

The invention relates to a device (10) for hardening an UV varnish and thermohardening varnish or the similar for coating an object, in particular a motor car body (12) comprising at least one emitter (48, 48″) generating electromagnetic radiation. The inventive device is provided with a conveying system (14, 16) which conveys the object (12) closely to the emitter (48, 48″) and, afterwards removes it. Said conveying system comprises an overhead travelling carriage (16) which is translatory displaceable along at least one guideway (14) suspended above at least one emitter (48, 48″). Two suspension supports (66) extending downwards and making it possible to suspend the object (12) are arranged successively in a longitudinal direction (85) on a chassis (50) of the travelling carriage (16). The length of said suspension supports is individually modifiable with the aid of a motor.

The invention relates to a device for curing a coating of an object, in particular a vehicle body, the coating consisting of a material that cures under electromagnetic radiation, in particular of a UV lacquer or a thermally curable lacquer, comprising

a) at least one emitter generating electromagnetic m radiation;

b) a conveying system which conveys the object into the vicinity of the emitter and away from it again.

Lacquers that cure under UV light have previously been used primarily for lacquer coating sensitive objects, for example wood or plastics material. In this case the advantage of these lacquers being able to be polymerised at very low temperatures is particularly useful. As a result, the material of the objects is prevented from disintegrating or gas emission. However, curing of coating materials under UV light has yet further advantages which accordingly make this coating process interesting for use in other areas as well. These advantages are, in particular, the short curing time, which is immediately reflected, in particular in coating processes which operate in a continuous cycle, in a reduction in the plant length which is connected with enormous cost savings. At the same time the apparatus with which the gases to be introduced into the interior of the device are conditioned, can be reduced in size, and this also contributes to cost savings. Finally, the low operating temperature—even with objects which could themselves tolerate higher curing temperatures per se—is advantageous for reasons of conserving energy and, more precisely, thermal energy in particular.

Many of the objects which one would like to be able to coat with UV-curing materials, such as vehicle bodies, have a very uneven, often three-dimensionally curved surface, so it is difficult to introduce these objects into the radiation region of a UV emitter such that all surface regions have approximately the same spacing from the UV emitter and the UV radiation substantially strikes the respective surface region of the object at a right angle.

Known devices of the type mentioned at the outset, as have previously been used in the wood and printing industries, are not suitable for UV radiation as the UV emitter(s) was/were immovably arranged and the objects were moved past the UV emitter(s) in a more or less fixed orientation by the conveying system.

Recently lacquers have moreover been developed which cure under the effect of heat in an inert gas atmosphere to form very hard surfaces. The heat can be supplied in a wide variety of ways in this case, thus for instance by convection or infrared radiators. In the latter case, similar problems to those described above for the use of emitters occur. In particular, in other words, all surface regions of the object to be lacquer coated are supposedly moved past the infrared emitter at approximately the same spacing.

The object of the present invention is to configure a device of the type mentioned at the outset such that coatings may also be cured on very uneven objects with a complex shape, in particular vehicle bodies, so as to achieve a good result.

This object is achieved according to the invention in that the conveying system comprises a suspended carriage which can be moved in a translatory manner along at least one travel way and is suspended over the at least one emitter, and in that two downwardly extending suspension supports for suspension of the object are arranged one behind the other in the longitudinal direction on a bogie truck of the suspended carriage, the length of which supports can be changed independently of each other with the aid of a motor.

According to the invention, a conveying system with a suspended carriage, as is already used per se for immersion coating vehicle bodies or other objects, is used. The present invention has found that an object may be pivoted using a suspended carriage about an axis that extends transversely to the travel way if the lengths of the suspension supports are unevenly changed with the aid of a motor, and, in particular, in opposite directions to each other. Superimposing a pivoting movement of this type about a transverse axis with a translation of the suspended carriage along the travel way, allows, for example, the spacing between an emitter arranged below the suspended carriage and a downwardly pointing surface of the object to be kept substantially constant.

The suspended object is thus uniformly exposed to a quantity of light and a light intensity as are required for curing the material. Complete curing occurs only if, on the one hand, the electromagnetic radiation strikes the coating with an intensity that is above a threshold and, on the other hand, this intensity is also maintained for a specific period. In the event of insufficient intensity, a polymerisation reaction does not occur or proceeds only incompletely. Even with sufficient intensity only incomplete curing is again attained with excessively short radiation.

A particularly advantageous embodiment of the invention is characterised in that at least one of the suspension supports comprises two belts or chains which can be individually wound with the aid of a motor and which act on either side of the object at a supporting structure receiving the object. The supporting structure receiving the object is thus suspended at three, or, if both suspension supports are configured in this manner, four, points of the suspended carriage bogie truck. As a result of individual changes in the length of the belts or chains, the supporting structure and the objected fastened thereto may also be pivoted about an axis extending along the travel way in addition to about an axis extending transversely to the travel way. This in turn allows even lateral surfaces of the object to be oriented with respect to the lateral emitters such that even in this case all surface regions can be uniformly and completely cured in the region in which the electromagnetic radiation generated by these emitters acts.

It is also preferred if the conveying system comprises a plurality of suspended carriages which each comprise a separate driving unit for a translatory movement along the travel way. The suspended carriages can thus convey the objects independently of each other and move them past the at least one emitter. The travel path can in the process comprise, for example, one rail, two rails or even a roller conveyor, as is known per se in connection with conveying systems of this type in the prior art.

An embodiment of the invention is particularly preferred in which the device comprises a container that is open at the top and arranged below the travel way, and into the interior of which the object can be introduced with an extension of the length of the suspension supports, and of which the interior can be subjected to electromagnetic radiation from the at least one emitter. This container ensures that no electromagnetic radiation and no gases can escape in the lateral direction, which is to be avoided for the sake of the operators' health. In this embodiment of the invention, the suspended carriages, constructed for immersion and emergence of objects in/from liquid containers, develop their advantages particularly well. Lowering into a container in particular may be managed very easily with suspended carriages of this type as even large differences in height may be easily bridged. The container can in this case be configured as an independent component or as an appropriately lined base region of a cabin housing or the like.

The arrangement of the emitters on or in the container can vary:

It is thus possible that at least one emitter is fitted in a wall or in the base of the container. With three-dimensionally curved surfaces of objects to be treated, the solution in which at least one emitter is fitted in the opposing side walls extending parallel to the translational movement of the objects and in at least one of the two end walls extending perpendicular to the translational movement of the objects, as well as in the base of the container, is preferred. In this case all sides or surface regions of the object may be reached by electromagnetic radiation without problem.

The most universally appropriate embodiment of the invention is obviously that in which a large number of emitters is arranged on all walls and in the base of the container.

In the above embodiments, in which the emitters are arranged in the walls or in the base of the container, the emitters form substantially large-area emitters.

However, emitters may also advantageously be used which are configured as linear emitters. In this case an embodiment of the invention is particularly advantageous in which a plurality of emitters is provided in a U-shaped arrangement with two substantially vertical legs and a substantially horizontal base. The object to be treated is “threaded” as it were between the vertical legs of the overhead frame.

The arrangement of the emitters on the substantially vertical legs can be adapted to the course of the lateral surfaces of the object. Thus even with curved lateral object surfaces, uniform and complete curing of the coating can be achieved on the lateral surfaces of the object.

If the downwardly pointing surface of the object is very curved it may be advantageous to adapt the arrangement of emitters on the substantially horizontal base to the course of the downwardly pointing surface of the object. A segment-like arrangement of the emitters on the horizontal base allows the object to be moved past the arrangement of emitters in such a way that the spacing thereof from the downwardly pointing surface of the object is largely constant.

It is particularly preferred if a protective gas can be supplied to the interior of the container. The protective gas primarily has the function of preventing the presence of oxygen in the radiation region of the emitters as oxygen can be converted into harmful ozone, in particular under the influence of UV light, and also affects the course of the polymerisation reaction.

The protective gas should be heavier than air, as is the case, for example, with carbon dioxide, so the protective gas only escapes slowly from the container that is open at the top. The container is thus filled with the heavy protective gas similarly to with a liquid.

There is an inlet for the protective gas preferably in the immediate vicinity of the at least one emitter. The protective gas can thus simultaneously exercise a cooling effect on the at least one emitter.

It is also preferred if a moving reflector is associated with at least one emitter on the side remote from the object. Using this moving reflector the direction of the electromagnetic radiation generated by the at least one emitter may be purposefully influenced. This allows the available effective range of the electromagnetic radiation to be enlarged.

The container can be provided with a reflective layer on at least one inner surface. Lower power emitters may be used as a result.

The reflective effect is intensified in that the reflective layer is uneven. Under these circumstances the reflections take place at very different angles, so the interior of the container is very uniformly filled with electromagnetic radiation with very varied directions of propagation.

The layer may, for example, consist of an aluminium foil. This has a very good reflective capacity for electromagnetic radiation and is also very inexpensive. Unevenness can be easily created by creasing the aluminium foil.

The device according to the invention should comprise a cabin housing which prevents uncontrolled escape of gases and electromagnetic radiation, in particular UV light. Both of these would pose a health risk to operators.

A sluice for the suspended carriage can be provided at the inlet and outlet of the cabin housing respectively. These sluices prevent relatively large quantities of air from passing from the external atmosphere into the cabin housing as the suspended carriage is driven into and out of the cabin housing. The sluices also protect operators from harmful electromagnetic radiation.

As permeation of air, in particular oxygen, into the interior of the cabin housing is not completely eliminated with sluices either, however, an apparatus for removing oxygen from the atmosphere inside the cabin housing is expediently provided. This apparatus can include a catalyst for catalytically binding the oxygen, a filter for absorption or a filter for adsorption of oxygen.

If the coating material initially still contains relatively large amounts of solvent, as is the case for example with water-based lacquers, the device for removing solvent from the material of the coating can comprise a pre-heating zone.

If, on the other hand, powdery materials are to be processed, the device for initial gelling of this powdery material can have a corresponding pre-heating zone.

In principle manual control of the suspended carriage is possible if an operator can visually monitor the irradiation process and controls the corresponding lifting and lowering movements as a function of the external contour of the irradiated object.

However, the device preferably comprises a controller via which the length of the suspension supports can be automatically adapted to the vertical dimensions of the object. This means that where the object is particularly high, the length of the suspension supports is shortened, so the spacing from an emitter arranged below the suspended carriage is substantially constant. Where, on the other hand, the object is flatter, the length of the suspension supports is increased, so the object is lowered and brought closer to the emitter.

In an advantageous development of this embodiment the length of the suspension supports can be changed by the controller in such a way that, during a conveying movement of the object past the at least one emitter, the quantity of electromagnetic radiation striking the material per unit of area and the intensity thereof do not fall below respectively predeterminable thresholds required for curing. This ensures that all downwardly pointing surface regions of the object are exposed to the same radiation intensity and substantially the same quantity of radiation, i.e. the same irradiation in the photometric sense.

It is also preferred in this configuration of the invention if the length of the suspension support can be changed by the controller such that, during a conveying movement of the object past the at least one emitter, the spacing in the vertical direction between the object and the at least one emitter is at least approximately constant. If this constant value is only just above the threshold required for curing, more severe “overexposure” which, for example, can lead to embrittlement or discoloration, is avoided.

It is also preferred in this connection if the controller comprises a memory for storing three-dimensional shape data of the object. The controller can be provided with this three-dimensional shape data, for example from a higher-order data processing system.

As an alternative, or, for control reasons, in addition, to this the device can comprise a measuring station upstream—optionally also directly upstream—of the at least one emitter in the conveying direction, by means of which station the three-dimensional shape data of the object can be detected. This data can subsequently be used for movement guidance of the object upstream of the emitter(s).

In a particularly simple embodiment the measuring station merely comprises one or more light barrier(s) which is/are preferably arranged in the immediate vicinity of the at least one emitter and cooperate(s) with the controller. If the object to be irradiated interrupts a light barrier, a corresponding deflection of the object is brought about in real time.

More accurate detection of the three-dimensional shape is possible if the measuring station comprises an optical sampler which, for example, can contain an infrared light source, by which the object can be sampled in a scanner-like manner in at least one direction.

A further possibility of precisely detecting the three-dimensional shape is provided by digital image processing and recognition of video images of the object. The measuring station thus comprises a video camera and an apparatus for digital image recognition.

At the output side the device can comprise a post-heating zone to complete curing.

In the case of objects with cavities it may be expedient to arrange a further inlet for protective gas within the input-side sluice in such a way that the cavities are flushed with protective gas, so air contained therein is displaced.

The electromagnetic radiation is preferably UV light or infrared radiation.

Further features and advantages of the invention emerge from the following description of the embodiments with reference to the drawings, in which:

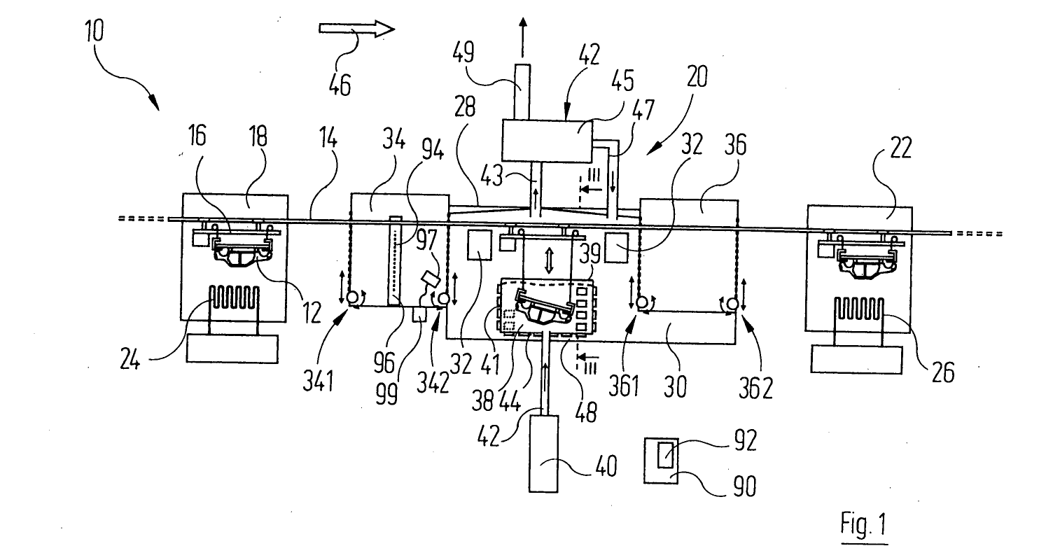

FIG. 1 shows a curing device for curing UV lacquers in a highly simplified longitudinal section that is not to scale;

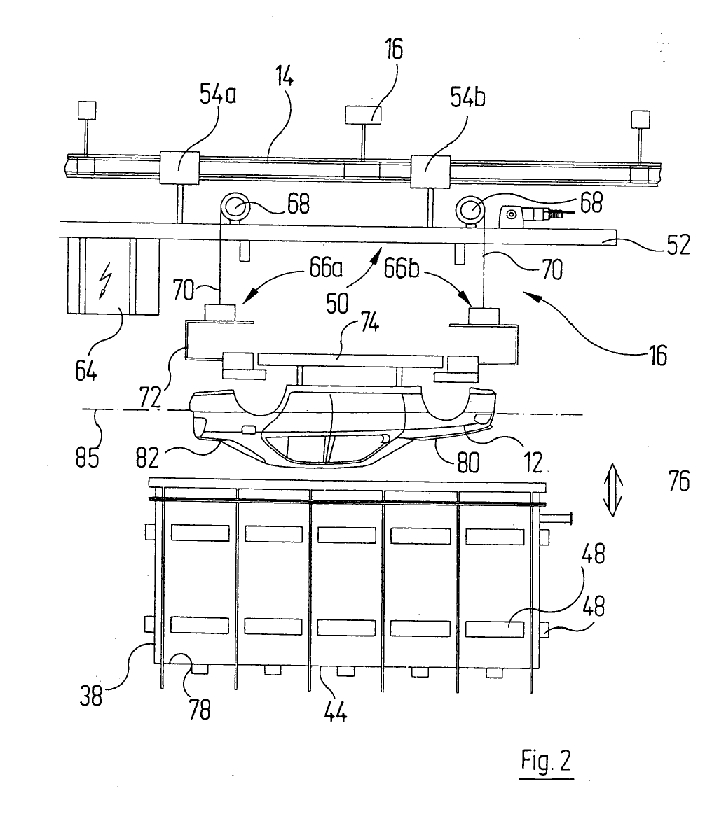

FIG. 2 shows an enlarged view of a portion of the curing device shown in FIG. 1;

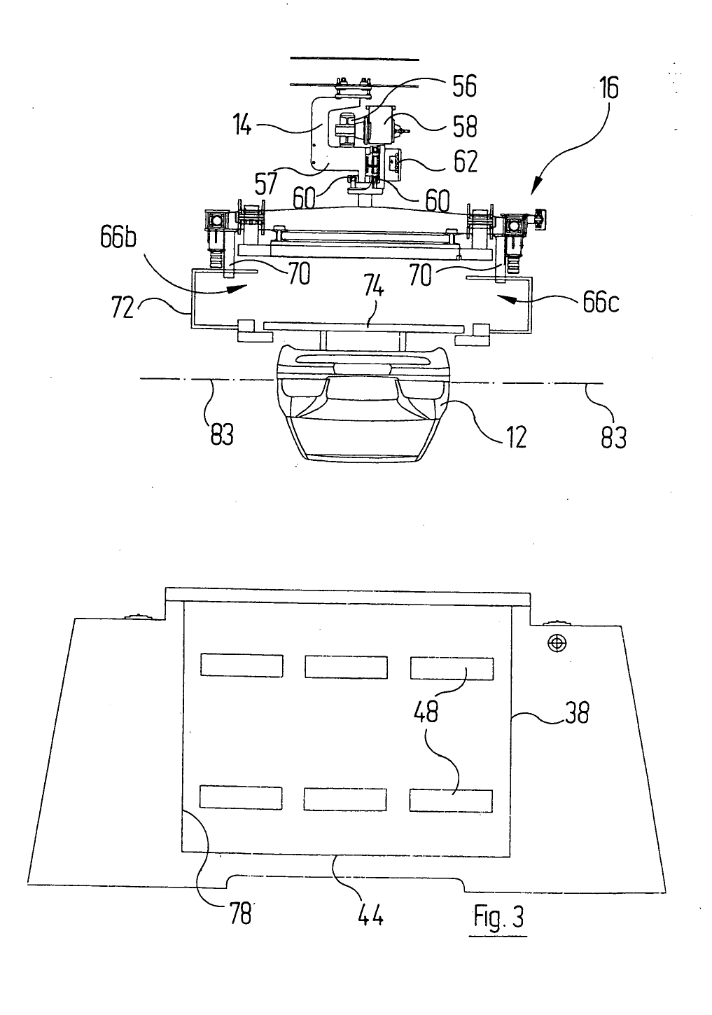

FIG. 3 shows a cross-section along the line III-III through a portion of the device shown in FIG. 1;

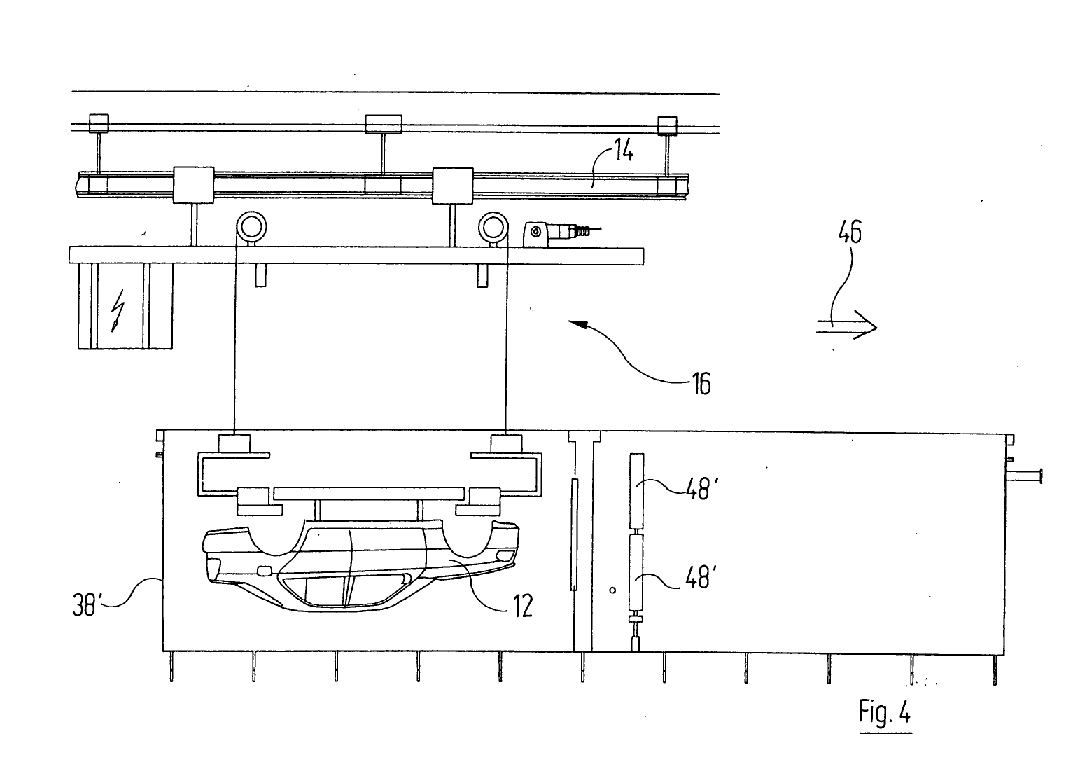

FIG. 4 shows a further embodiment for a curing device in a view corresponding to FIG. 2.; and

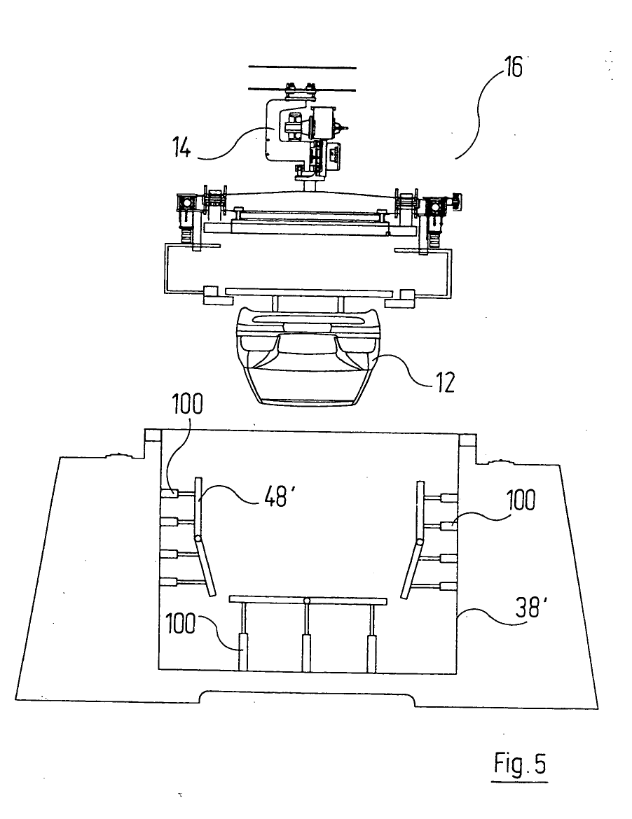

FIG. 5 shows the embodiment of FIG. 4 in a view corresponding to FIG. 3.

FIG. 1 shows a device for curing UV lacquers in a highly simplified longitudinal section that is not to scale, the device being designated as a whole by 10. The curing device 10 illustrated by way of example is part of a lacquer coating unit which is provided for applying multi-layer lacquer coatings to preassembled car bodies 12. The curing device 10 comprises an overhead conveying system, which is known per se, for the vehicle bodies 12 and comprises an overhead rail 14 and suspended carriages 16 hung thereon. Using this overhead conveying system the vehicle bodies 12 are supplied to the curing device 10 and conveyed through the individual stations thereof. These stations are a pre-heating zone 18, an irradiation device 20 and a post-heating zone 22.

The pre-heating zone 18 and the post-heating zone 22 contain heating devices, indicated by 24 and 26 respectively and configured as hot air heaters. Alternatively, heating by means of IR emitters or with the aid of a magnetron for generating microwaves may also be considered. The pre-heating zone 18 can perform different functions, depending on the type of coating material. If this material is solvent based, for example a water-based paint, the solvents are largely removed in this case. If powdery material is involved, the pre-heating zone 18 is used to initially gel the powder and to thus make it ready for polymerisation.

The irradiation device 20 comprises a cabin housing 28 which is constructed such that neither gas exchange with the environment nor escape of UV light is possible. To be able to observe the processes in the interior 30 of the cabin housing 28 from the outside, windows 32 are let into the side walls of the cabin housing 28, which are permeable to visible light but impermeable to UV light.

To prevent exchange of gases with the environment, the irradiation device 20 comprises an inlet sluice 34 and an outlet sluice 36 which the suspended carriages 16, with the vehicle bodies fastened thereto, have to pass when driving into and out of the interior 30. The inlet sluice 34 and the outlet sluice 36 are in each case constructed in the illustrated embodiment as double sluices with two moving rollup doors 341, 342 and 361, 362. Owing to the overhead rail 14 the rollup doors 341, 342 and 361, 362 are rolled up from the bottom to keep a passage slot for the rail 14 as short as possible.

A trough-like container 38, which can be filled with a protective gas that is stored in a gas holder 40 and can be introduced via a line 42 ending in the base of the container 38, is arranged in the interior 30 of the cabin housing 28. In the illustrated embodiment the protective gas is carbon dioxide as in the gaseous state this is heavier than air and thus behaves similarly to a liquid in the container 38 that is open at the top. The quantity of protective gas supplied via the line 42 is in dynamic equilibrium with the quantity of protective gas that escapes inter alia via the inlet and outlet sluices 34 and 36 respectively.

The substantially cuboidal container 38 comprises at its base surface 44, its side walls 39 extending parallel to the conveying direction, designated by 46, of the conveying system and also at its end walls 41 perpendicular hereto a large number of UV emitters 48 which direct UV light into the interior of the container 38. For the sake of clarity the UV emitters which are arranged on the side wall 39 visible to the observer, are shown only in part. The light exit faces of the UV emitters 48 are covered by an IR filter, so the heat radiation generated by the UV emitters 48 can only pass into the interior of the container 38 to a small extent.

Instead of a central line 42 for introducing protective gas, a large number of lines may also be provided which end right next to the UV emitters 48 on the walls of the container 38. The protective gas flushes the portions of the UV emitters 48 which become hot during operation. Protective gas may also be purposefully directed toward vehicle bodies 12 immersed therein in the container to displace undesirable oxygen-containing residual gases which under the influence of UV light can lead to the formation of ozone and affect the polymerisation reaction.

The interior 30 is connected to a regeneration circuit 42 that has the function of removing oxygen, which is introduced into the interior 30 by the vehicle bodies 12 or penetrates when the inlet sluice 34 or outlet sluice 36 is opened, from the atmosphere prevailing in the interior 30. For this purpose, gas is continuously removed from the interior 30 via a line 43 and conveyed, for example via a catalyst 45 which catalytically binds the oxygen. A portion of this gas is returned to the interior 30 of the cabin housing 28 via a line 47 while a further portion is discharged into the external atmosphere via a line 49.

Details of the overhead conveying system and container 38 will be described hereinafter with reference to FIGS. 2 and 3 which show a detail of the interior 30 of the cabin housing 28 in an enlarged longitudinal section and cross-section respectively.

FIG. 2 shows that the rail 14 of the overhead conveying system is fastened via anchors 16 to an overhead structure (not shown). The suspended carriage 16 comprises a bogie truck 50 which for its part consists of a platform 52 and running gear groups 54a, 54b fastened thereto and extending upwards. The running gear groups 54a, 54b, which can be seen particularly clearly in the cross-sectional view of FIG. 3, each contain a running wheel 56 which can roll from the top on a horizontal leg 57 of the rail 14 which is substantially C-shaped in cross-section. The running wheel 56 can be driven by a drive unit 58 in the form of an electric motor. Undesirable tilting of the suspended carriage 16 about a longitudinal axis is prevented by guide rollers 60 which enclose a shoulder 62 formed on the lower leg 57 of the rail 14. An accumulator 64 is provided on the platform 52 of the bogie truck 50 for supplying power to the drive unit 58. Alternatively, the power can also be supplied via contact rails let into the rail 14.

A respective pair of suspension supports hangs from the front and back of the platform 52 in the longitudinal direction, of which only the suspension supports 66a, 66b facing the observer can be seen in FIG. 2. FIG. 3 shows a further suspension support 66c. Each suspension support 66 comprises a roller 68 driven by means of a motor, and a belt 70, which can be wound thereon and is made of a UV-resistant material, and a fastening bracket 72 provided thereon. The fastening bracket 72 engages beneath a supporting structure 74 to which the vehicle body is fastened. This supporting structure 74 can, for example, be what is referred to as a skid carrier which is used for conveying vehicle bodies 12 on roller conveyors. In the figures the supporting structure 74 is shown slightly distanced from the fastening brackets 72 to make it clear that the connection between the fastening bracket 72 and the supporting structure 74 can be easily broken.

As a result of this suspension of the supporting structure 74 at the four corner points with the aid of the fastening brackets 72, the vehicle body 12 can be moved aloft in the direction indicated by the arrow 76 but also in the longitudinal direction of the vehicle body 12 and pivoted in the transverse direction thereof. For this purpose, it is only necessary to drive the drive units for the rollers 68 in different ways in order to thus individually change the length of the belts 70.

The UV emitters 48 let into the base face 44, the side walls 39 and the end walls 41 of the container 38 can be seen in the container 38 that is visible below the vehicle body 12. The UV emitters 48, which are shown two-dimensionally, can, for example, contain one or more tubular lighting means or a large number of approximately punctiform light sources. All inner surfaces of the container 38, where they are not occupied by exit faces of the UV emitters 48, are covered by a reflective aluminium foil 78 which has also been made uneven, for example by creasing or by other irregular elevations.

The above-described curing device 10 operates as follows:

During operation the UV emitters 48 are functioning so the entire interior of the container 38 is flooded with UV light which is additionally reflected by the creased aluminium foil 78, provided on the inner surfaces of the container 38, in a large number of different directions and is thus evened out. The UV emitters 48 are cooled by the gaseous carbon dioxide supplied via the line 42. The thus only insubstantially pre-heated carbon dioxide gas enters the container 38 and fills it from the bottom up. The carbon dioxide issuing from the top of the container 38 and which can be mixed to a small extent with gas emissions from the lacquer curing on the vehicle body 12 as well as ozone, passes into the interior 30 of the cabin housing 28 and from there is removed by suction via the outlet 43. Removal by suction can also take place directly at the upper edge of the walls of the container 38.

It is assumed that a plurality of lacquer layers have already been applied in an upstream coating direction of the lacquer coating plant. The upper lacquer layer is a clear lacquer which is applied as a powder to the lacquer layers that already exist. The clear lacquer polymerises under the effect of UV light and thus cures. A prerequisite for this is that the powdery lacquer is converted in advance into a more or less liquid, gel-like state. The pre-heating zone 18 is used for this purpose, in which a vehicle body 12 provided therein is heated to a temperature of about 90° C. At this softening temperature the powder is transformed into said gel-like state.

From the pre-heating zone 18 the suspended carriage 16, with vehicle body 12 hung therefrom, is fed to the inlet sluice 34. By successively opening and closing the rollup doors 341, 342 of the inlet sluice 34 the suspended carriage 16 with the vehicle body 12 is introduced into the interior 30 of the cabin housing 28 without relatively large quantities of the protective gas contained therein being able to penetrate to the outside.

As soon as the suspended carriage 16 with the vehicle body 12 suspended thereon has reached the position above the container 38, shown in FIG. 2 or 3, the vehicle body 12 is lowered into the container 38 by unwinding the belts 70 from the rollers 68. The now gel-like clear lacquer is accordingly actually cured under the effect of the UV light generated by the UV emitters 48. As the protective gas displaces the air originally present in the interior 30, UV light is prevented from converting the molecular atmospheric oxygen into ozone, which would affect the polymerisation reaction.

So the front hood 80 and the tailgate 82 of the vehicle body 12 in particular also receive the quantity of UV light required for curing (the quantity of light or dose of light is designated in photometry as irradiation with the unit Ws/m² or J/cm²), the vehicle body 12 immersed in the container 38 is pivoted about a transverse axis 83 (see FIG. 3) of the vehicle body 12 such that the front hood 80 and then the tailgate 82 are also positioned sufficiently close to the UV emitters 48 let into the base face 44 of the container 38. For this purpose, the drive units for the rollers 68 can, for example, be driven in such a way that the leading and trailing pairs of belts 70 are shortened or lengthened in opposite directions.

As the lateral surfaces of the vehicle body 12 are also highly curved, as can be seen in particular in the cross-sectional view of FIG. 3, the pair of belts 70 arranged on both longitudinal sides of the vehicle body 12 can be changed in length such that the vehicle body 12 performs a pivoting movement about its longitudinal axis 85 (see FIG. 2). All regions of the lateral surfaces of the vehicle body 12 may thus be brought sufficiently close to the UV emitters 48 let into the side walls 39 of the container 38.

After the curing process in the container 38 has finished, the vehicle body 12 is raised again by shortening the belts 70 evenly. The suspended carriage 16 with the vehicle body 12 is subsequently supplied via the outlet sluice 36 to the post-heating zone 22 in which a temperature of 105° C. prevails. The vehicle body 12 stays there for approximately five to ten minutes, during which the polymerisation reaction is completely concluded. The time and temperature can vary in this case depending on the coating material.

For controlling these processes there is provided a central controller which is indicated in FIG. 1 by 90. Via a bus system the controller 90 controls the individual servomotors within the curing device 10 and in particular the suspended carriage 16. As controllers of this type for suspended carriages are known in terms of principle in the prior art, an illustration of the details of the bus system, etc. will be dispensed with.

In the controller 90 three-dimensional shape data of the vehicle body 12 is stored in a memory 92, the data being required to pivot the vehicle body 12 in the container 38 in the above-described manner along the longitudinal axis 85 and the transverse axis 83. This three-dimensional shape data can, for example, be retrieved from a higher-order data processing system in which data relevant to all vehicle bodies 12 passing through the curing device 10, such as type and colour of the lacquer coating and body type and shape, is stored. All that is then required is a reader which recognises the type of vehicle body 12 entering the irradiation device 20, so the three-dimensional shape data associated with this type can be retrieved.

Alternatively, or, for control purposes, additionally it is also possible to ascertain the requisite three-dimensional shape data using a measuring device 94 which is arranged inside the inlet sluice 34 (see FIG. 1). The measuring device 94 has a U-shaped frame to which a large number of optical samplers 96 with infrared light sources are fastened in the vertical direction and transversely to the conveying direction 46. The optical samplers 96 detect in a scanner-like manner the external contour of the vehicle body 12 as it passes through the measuring device 94.

The measuring device can alternatively or, as shown in FIG. 1, additionally comprise a video camera 97 with an image recognition device 99 associated therewith. The video camera 79 produces a digital image of the vehicle body 12 from which the three-dimensional shape of the vehicle body is derived in the image recognition device by algorithms known per se.

FIGS. 4 and 5 show an alternative embodiment for the container 38 and the UV emitters 48 arranged therein in views derived from FIGS. 2 and 3. The alternative embodiment differs from that described above merely in that UV emitters 48 are not distributed over the entire inner surface of the container 38, as is the case with the embodiment shown in FIG. 1 to 3. Instead, a U-shaped arrangement of a total of six linear UV emitters 48′, which are articulated to each other in pairs and can be adapted to the cross-section of the vehicle body 12 by way of hydraulic adjusting elements 100, are located in this case in a container 38′ that is extended in the longitudinal direction.

In this embodiment the vehicle body 12 is initially also let into the container 38′ in the vertical direction. The suspended carriage 16 in the conveying direction 46 is subsequently slowly set in motion in the conveying direction 46, so the vehicle body 12 suspended on the suspended carriage 16 is passed between the arrangement of the UV emitters 48′. If the cross-sectional contour of the vehicle body 12 changes significantly in it longitudinal direction, the UV emitters 48′ can be adjusted accordingly by actuating the adjusting elements 100.

As an alternative or in addition to this type of compensation there is, however, also the possibility in this case of also optimally positioning the lateral surfaces of the vehicle body 12 with respect to the UV emitters 48′ as a result of the above-described pivoting movements of the vehicle body 12 around the longitudinal axis 85. The UV light generated by the UV emitters 48′ can subsequently strike the relevant surface region substantially at a right angle.

If needed, the translational movement of the suspended carriage 16 may also be interrupted or reversed, so individual surface regions on the vehicle body 12 are irradiated for longer than others.

In the embodiment shown in FIGS. 4 and 5, the measuring station 96 can also be arranged directly upstream of the UV emitters 48′ in the conveying direction 46. If the measuring station 96 comprises, for instance, one or more light barriers in this case, a corresponding deflection of the vehicle body 12 can be brought about in real time by changing the length of the belts 70 when the vehicle body 12 arrives in the detection range of a light barrier.

The above embodiments are used for curing lacquers under UV light. However, they may also be used with lacquers which cure under the effect of heat, in particular in an inert gas atmosphere, in other words in a CO₂ or nitrogen atmosphere for example. In this case substantially only the UV emitters described need to be replaced by IR emitters. Other constructional adjustments connected with the change in electromagnetic radiation are known to a person skilled in the art and do not need to be described in more detail here.

1. Device for curing a coating of an object, the coating consisting of a material that cures under electromagnetic radiation, the device including
a) at least one emitter generating electromagnetic radiation; and,
b) a conveying system which conveys the object into the vicinity of the emitter and away from it again;
wherein the conveying system comprising a suspended carriage which can be moved in a translatory manner along at least one travel way and is suspended over the at least one emitter, and in that at least two downwardly extending suspension supports for suspension of the object are arranged one behind the other in the longitudinal direction on a bogie truck of the suspended carriage, the length of which supports can be changed independently of each other with the aid of a motor,
wherein the device comprises a controller via which the length of the suspension supports can be automatically adapted to the vertical dimensions of the object, and,
further wherein the length of the suspension supports can be changed by the controller in such a way that, during a conveying movement of the object past the at least one emitter, the quantity of electromagnetic radiation striking the material per unit of area and the intensity thereof do not fall below respectively predeterminable thresholds required for curing.

2. Device according to claim 1, wherein at least one of the suspension supports comprises two belts or chains which can be individually wound with the aid of a motor and which act on either side of the object at a supporting structure receiving the object.

3. Device according to claim 1, wherein the conveying system comprises a plurality of suspended carriages which each comprise a separate driving unit for a translatory movement along the travel way.

4. Device according to claim 1, further comprising a container that is open at the top and arranged below the travel way, and into the interior of which the object can be introduced by an extension of the length of the suspension support and of which the interior can be subjected to electromagnetic radiation from the at least one emitter.

5. Device according to claim 4, wherein at least one emitter is fitted in a wall or the base of the container.

6. Device according to claim 5, wherein at least one emitter is fitted in the opposing side walls extending parallel to the translational movement of the objects and in at least one of the two end walls extending perpendicular to the translational movement of the objects or in the base of the container.

7. Device according to claim 5, wherein a large number of emitters is arranged on all walls and in the base of the container.

8. Device according to claim 1, wherein a plurality of emitters are provided in a U-shaped arrangement with two substantially vertical legs and a substantially horizontal base.

9. Device according to claim 8, wherein the arrangement of the emitters at the substantially vertical legs is adapted to the course of the lateral surfaces of the object.

10. Device according to claim 8, wherein the arrangement of emitters at the substantially horizontal base is adapted to the course of the downwardly oriented surface of the object.

11. Device according to claim 4, wherein a protective gas can be supplied to the interior of the container.

12. Device according to claim 11, wherein the protective gas is heavier than air.

13. Device according to claim 11, further comprising an inlet for the protective gas in the immediate vicinity of the at least one emitter.

14. Device according to claim 1, wherein at least one emitter on the side remote from the object is associated with a moving reflector.

15. Device according to claim 4, wherein the container is provided on at least one inner surface with a reflective layer.

16. Device according to claim 15, wherein the layer is uneven.

17. Device according to claim 14, wherein the layer consists of aluminium foil.

18. Device according to claim 1, further comprising a cabin housing which prevents the uncontrolled escape of gases and electromagnetic radiation.

19. Device according to claim 18, wherein a respective sluice is provided for the suspended carriage at the inlet and outlet of the cabin housing.

20. Device according to claim 18, wherein an apparatus is provided for removing oxygen from the atmosphere within the cabin housing.

21. Device according to claim 20, wherein the apparatus for removing oxygen comprises a catalyst for catalytically binding the oxygen.

22. Device according to claim 20, wherein for removing oxygen, the apparatus comprises a filter for absorbing oxygen.

23. Device according to claim 20, wherein for removing oxygen, the apparatus comprises a filter for adsorbing oxygen.

24. Device according to claim 1, further comprising a pre-heating zone for removing the solvent from the material of the coating.

25. Device according to claim 1, further comprising a pre-heating zone for initial gelling of powdery material.

26. (canceled)

27. (canceled)

28. Device according to claim 1, wherein the length of the suspension supports can be changed by the controller in such a way that, during a conveying movement of the object past the at least one emitter, the spacing in the vertical direction between the object and the at least one emitter is at least approximately constant.

29. Device according to claim 1, wherein the controller comprises a memory for storing three-dimensional shape data of the object.

30. Device according to claim 1, wherein the device comprises a measuring station upstream of the at least one emitter in the conveying direction, by means of which station the three-dimensional shape data of the object can be detected.

31. Device according to claim 30, wherein the measuring station comprises at least one light barrier.

32. Device according to claim 31, wherein the measuring station comprises at least one optical sampler by which the object can be sampled in a scanner-like manner in at least one direction.

33. Device according to claim 32, wherein the optical sampler comprises an infrared light source.

34. Device according to claim 30, wherein the measuring station comprises a video camera and an apparatus for digital image recognition.

35. Device according to claim 1, further comprising a post-heating zone to complete curing.

36. Device according to claim 11, wherein within the inlet-side sluice, an inlet for protective gas is arranged in such a way that a cavity in the object is flushed with a protective gas.

37. Device according to claim 1, wherein the electromagnetic radiation is UV light.

38. Device according to claim 1, wherein the electromagnetic radiation is IR radiation.

39. Device according to claim 1, wherein the object is a vehicle body.
